(19) United States
(12) Patent Application Publication
(10) Pub. No.: US 2014/0255085 A1
(43) Pub. Date: Sep. 11, 2014

(54) STRUCTURAL BRACKETS FOR FLAT PACK FRAMES

(71) Applicant: SANMINA CORPORATION, San Jose, CA (US)

(72) Inventors: SHAUN DENSBERGER, Livermore, CA (US); DARREN MAY, CALGARY (CA); GLEN GOMMELS, Scottsdale, AZ (US); ERIC PRYOR, Union City, CA (US)

(73) Assignee: SANMINA CORPORATION, San Jose, CA (US)

(21) Appl. No.: 13/791,408

(22) Filed: Mar. 8, 2013

(51) Int. Cl. F16B 9/02

(52) U.S. Cl. CPC F16B 9/02
USPC 403/205

(57) ABSTRACT

A structural bracket, for use with flat pack frames, formed from a single flat sheet of metal that is constructed without the use of welding points so as to simplify the manufacturing process is provided. The flat sheet of metal may have a generally triangular configuration that includes notches at strategic locations in the sheet of metal to create flaps that may be folded over to form the sidewalls of the brackets. The sidewalls of the brackets may be used to secure vertical and/or horizontal rails together when assembling a flat pack equipment rack. Additionally, a pair of structural brackets may be secured together by fasteners forming a single bisected structural bracket. The utilization two separate brackets to form a single bisected structural bracket provides for a flat pack solution for equipment racks while being as structurally strong as a traditional, fully welded frame.

### FIELD

Various features relate to improvements to flat pack frames, such as equipment racks, and more particularly, to structural brackets for flat packed frames.

### BACKGROUND

Flat pack frames, such as equipment racks, are frames that are fabricated in flat parts and designed to be quickly and easily assembled. One advantage to flat parts is that they are space efficient, saving money for the manufacturer by reducing shipping and storage costs.

Each flat pack frame includes a plurality of elongate members which are joined together at corners of the frame. The frame includes a corner joint at which two horizontal elongate members and one vertical elongate member are joined together. The horizontal elongate members and vertical elongate member are secured together using one or more structural brackets or braces. The structural brackets included in the flat pack frame assemblies are designed only for securing the elongate members together and do not take the specific needs of the customers into account. For example, existing structural brackets do not take into account modularity, structural strength and fastener loading.

To accommodate the needs of consumers while also reducing manufacturing costs, various structural brackets that are adapted to the structural requirements of the consumer and are easy to manufacture by being formed from a single flat sheet of metal without welding are needed

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

According to one feature, a structural bracket for an equipment frame, such as a flat packed equipment frame, is provided. The structural bracket is formed from a single sheet of metal. The single sheet of metal is comprised of a bottom panel, a plurality of notches located at one or more locations on a perimeter of the bottom panel and a plurality of sidewalls integrally connected to the bottom panel and located between the plurality of notches. The plurality of sidewalls are folded approximately perpendicular to the bottom panel and each sidewall in the plurality of sidewalls has a bottom surface integrally connected with the perimeter of the bottom panel and a top surface opposite the bottom surface. In one aspect, the structural bracket has a triangular configuration.

In one aspect, the plurality of sidewalls comprises a first sidewall having a first side end and a second side end, a second sidewall having a first bottom end and a first top end where the first bottom end is positioned at an angle of approximately 45 degrees from the first side end of the first sidewall. The plurality of sidewalls also includes a third sidewall having a second bottom end and a second top end where the second bottom end is positioned at an angle of approximately 45 degrees from the second side end of the first sidewall.

In one aspect, the plurality of sidewalls further comprises a fourth sidewall, having a third side end and a fourth side end, integrally connected to the second top end of the third sidewall and positioned parallel to the first sidewall. The first sidewall includes one or more vertical slots, the second sidewall includes a first plurality of holes for receiving a first set of fasteners to secure the second sidewall to a first rail of an equipment frame, and the third sidewall includes a second plurality of holes for receiving a second set of fasteners to secure the third sidewall to a second rail of the equipment frame.

In one aspect, the first side of the first sidewall extends inwardly at an angle of approximately 45 degrees and includes one or more mounting holes for securing to a rail of an equipment frame.

In one aspect, the second sidewall includes a first plurality of connecting holes aligned with a second plurality of connecting holes in a second sidewall of a second structural bracket. Securing the second sidewall of the structural bracket to the second sidewall of the second structural bracket forms a single bisected structural bracket. Fasteners can be used to secure the second sidewall of the structural bracket to the second sidewall of the second structural bracket with fasteners.

In one aspect, the third sidewall of the structural bracket of the single bisected structural bracket is secured to a horizontal rail of the assembled equipment rack, and a third sidewall of a second structural bracket of the single bisected structural bracket is secured to a vertical rail in the assembled equipment rack. According to one embodiment, the third sidewall has a solid flat surface.

According to one feature, a flanged lap joint bracket for an equipment frame, such as a flat packed equipment frame, is provided. The flanged lap joint bracket is formed from a single sheet of metal. The single sheet of metal is comprised of an elongated member having a first end and a second end, a first flange, having a first plurality of holes, integrally connected to and extending perpendicularly from the first end of the elongated member, and a second flange, having a first plurality of holes, integrally connected to and extending perpendicularly from the second end of the elongated member. The elongated member is folded to an angle of approximately 90 degrees. In one aspect, the elongated member forms a vertical rail of an assembled equipment frame. In one aspect, the elongated member forms a horizontal rail of an assembled equipment frame.

In one aspect, the first flange has a first attachment end and a second attachment end, the second attachment end of the first flange is integrally connected to and perpendicular to the first attachment end of the first flange. The second flange has a first attachment end and a second attachment end, the second attachment end of the second flange is integrally connected to and perpendicular to the first attachment end of the second flange.

### BRIEF DESCRIPTION OF THE DRAWINGS

FIG. 1 illustrates a top perspective view of a structural member, according to one embodiment;

FIG. 2 illustrates a front side elevation view of the structural bracket of FIG. 1.

FIG. 3 illustrates a back side elevation view of the structural bracket of FIG. 1.

FIG. 4 illustrates a right side elevation view of the structural bracket of FIG. 1.

FIG. 5 illustrates a left side elevation view of the structural bracket of FIG. 1.

FIG. 6 illustrates a top plan view of the structural bracket of FIG. 1.

FIG. 7 illustrates a bottom plan view of the structural bracket of FIG. 1.

FIG. 8 illustrates the structural bracket of FIG. 1 in an assembled equipment rack.

FIG. 9 illustrates an enlarged perspective view of detail A of FIG. 8.

FIG. 10 illustrates a top perspective view of a structural bracket, according to one embodiment.

FIG. 11 illustrates a front side elevation view of the structural bracket of FIG. 10.

FIG. 12 illustrates a back side elevation view of the structural bracket of FIG. 10.

FIG. 13 illustrates a right side elevation view of the structural bracket of FIG. 10.

FIG. 14 illustrates a left side elevation view of the structural bracket of FIG. 10.

FIG. 15 illustrates a top plan view of the structural bracket of FIG. 10.

FIG. 16 illustrates a bottom plan view of the structural bracket of FIG. 10.

FIG. 17 illustrates a bisected structural bracket in an assembled equipment rack.

FIG. 18 illustrates an enlarged perspective view of detail A of FIG. 17.

FIG. 19A illustrates a flanged lap joint bracket in a flat configuration for use in an equipment rack, according to one embodiment.

FIG. 19B illustrates the flanged lap joint bracket of FIG. 19A in a formed configuration.

FIG. 20A illustrates a flanged lap joint bracket in a flat configuration for use in an equipment rack, according to one embodiment.

FIG. 20B illustrates the flanged lap joint bracket of FIG. 20A in a formed configuration.

FIG. 21 illustrates an equipment rack assembled using flanged lap joint brackets.

FIG. 22 illustrates enlarged perspective views of detail A and detail B of FIG. 20.

FIG. 23 illustrates a semi-exploded view of a lap joint bracket connection.

### DETAILED DESCRIPTION

In the following detailed description, numerous specific details are set forth in order to provide a thorough understanding of the embodiments. However, it will be understood by one of ordinary skill in the art that the embodiments may be practiced without these specific details. For example, operations may be shown in block diagrams, or not be shown at all, in order not to obscure the embodiments in unnecessary detail. In other instances, well-known operations, structures and techniques may not be shown in detail in order not to obscure the embodiments.

In the following description, certain terminology is used to describe certain features of one or more embodiments. The term “rack” may refer to any type of frame-like structure adapted to hold and display equipment. The term “fastener” or “fastening member” may refer to any type of device for connecting metal, plastic and other materials in common hardware construction, including screws, bolts, nuts, washers, rivets, cotter pins, clevis pins, studs, threaded rods and other mechanical connectors. The term “notch” may refer to any elongated cut, slice or removal of metal from a single piece of sheet metal. Notches may extend from an outer perimeter, of the single piece of sheet metal, horizontally inward. The term “hole” may refer to any opening through a structure and/or component (or part), or a hollowed-out place in a structure and/or component, including apertures, bores, cavities, chambers, grooves, notches, and passages. According to one aspect, a structural member that is easy to manufacture while also minimizing the loss in strength due to weld removal is provided.

According to one aspect, a structural bracket, for use with flat pack frames, formed from a single flat sheet of metal that is constructed without the use of welding points so as to simplify the manufacturing process is provided. The flat sheet of metal may have a generally triangular configuration that includes notches at strategic locations in the sheet of metal to create flaps that may be folded over to form the sidewalls of the brackets. The sidewalls of the brackets may be used to secure vertical and/or horizontal rails together when assembling an equipment rack. According to another aspect, a pair of structural brackets may be secured together by fasteners forming a single bisected structural bracket. The utilization two separate brackets to form a single bisected structural bracket provides for a flat pack solution for equipment racks while being as structurally strong as a traditional, fully welded frame.

### Narrow Width Structural Bracket

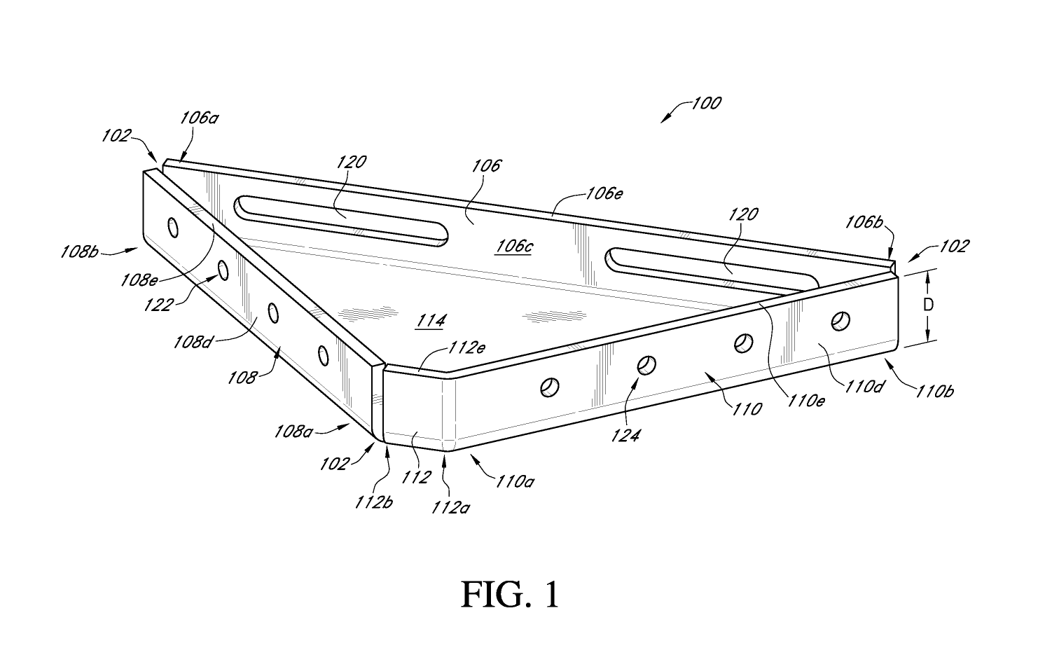

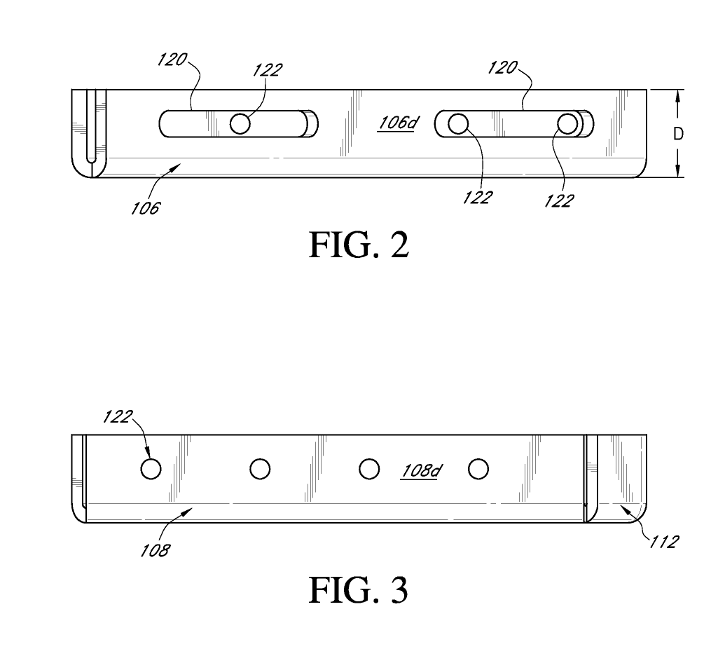

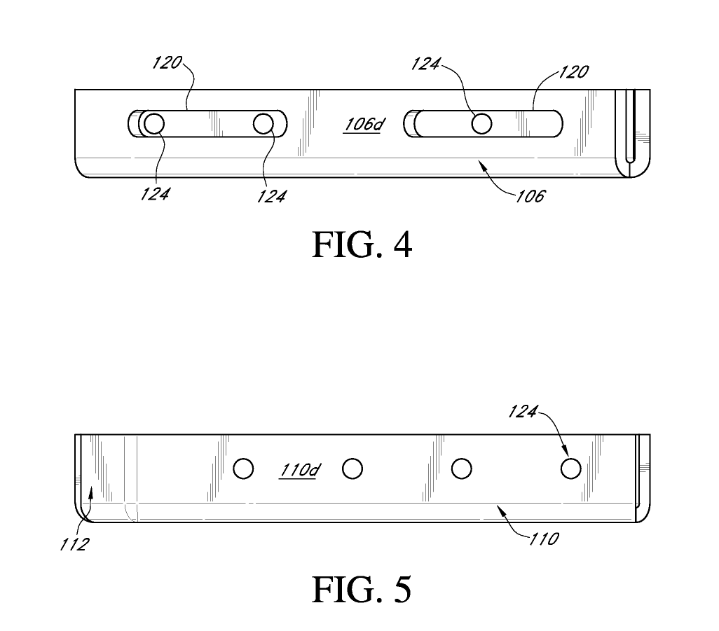

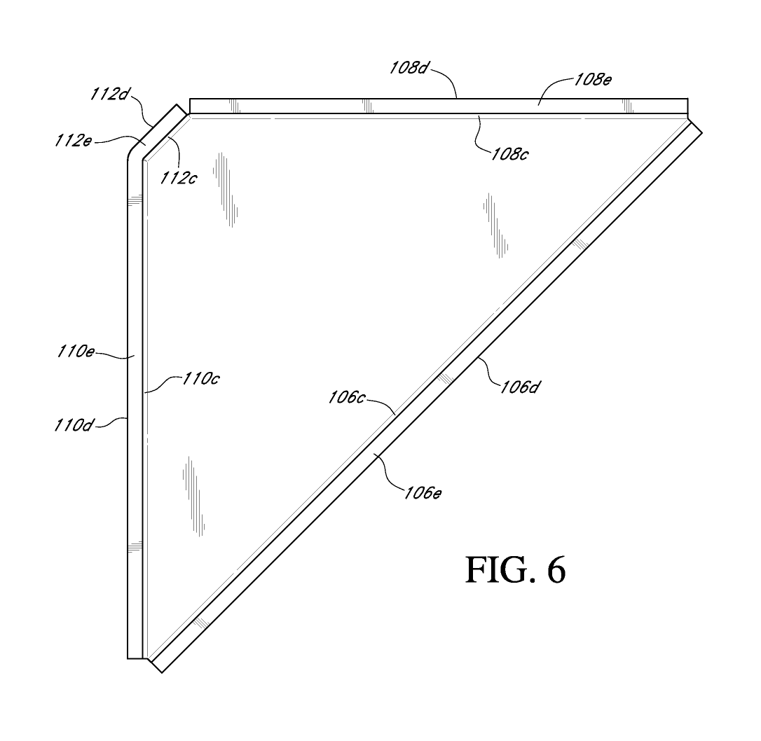

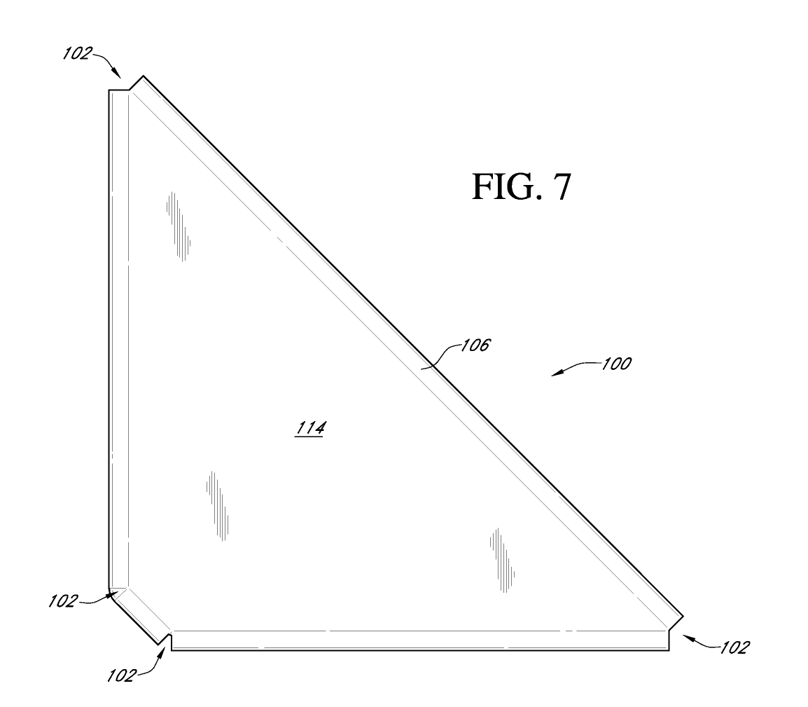

FIG. 1 illustrates a top perspective view of a structural bracket 100, according to one embodiment. FIG. 2 illustrates a front side elevation view of the structural bracket of FIG. 1. FIG. 3 illustrates a back side elevation view of the structural bracket of FIG. 1. FIG. 4 illustrates a right side elevation view of the structural bracket of FIG. 1. FIG. 5 illustrates a left side elevation view of the structural bracket of FIG. 1. FIG. 6 illustrates a top plan view of the structural bracket of FIG. 1. FIG. 7 illustrates a bottom plan view of the structural bracket of FIG. 1. The following discussion refers interchangeably to FIGS. 1-7.

The structural bracket 100 may comprise a single flat sheet of metal that is constructed without the use of welding points so as to simplify the manufacturing process. The structural bracket 100 may be formed having a narrow width so that it may be utilized with a flat pack hardware rack while minimizing the loss in structural strength due to weld removal. That is, the narrow width of the structural bracket 100 allows it to be included as part of a flat pack frame while also minimizing the structural strength loss of the structural bracket 100 as a result of constructing the structural bracket 100 without the use of welding points. The structural bracket 100 may provide structural rigidity by using both friction and mechanical interference where friction is produced by preloading the fasteners used to attach the bracket to its respective rails (or beams).

According to one embodiment, the single flat sheet of metal used to form the structural bracket 100 may have a generally triangular configuration. Notches (See FIG. 7) may be made at strategic locations in the sheet of metal to create flaps that may be folded over to form the sidewalls of the brackets. As shown in FIG. 7, the notches 102 may be located at corners of the sheet of metal and extend inwardly a distance D (See FIG. 1), where D is equal to the vertical length of the sidewalls and where the vertical length is perpendicular to a bottom panel 114.

The single flat sheet of metal may have an upper surface and a lower surface opposite the upper surface. The distance between the upper surface and the lower surface may correspond to the vertical height or the thickness of the flat sheet of metal. When the notches 102 are made, they may extend inwardly a distance D, as discussed above, and downwardly partially or completely through the thickness of the sheet of metal. According to one embodiment, notches that extend partially through the thickness of the sheet of metal maintaining a thin layer of the sheet of metal configured to act as a hinge.

According to one embodiment, the first, second, third and fourth sidewalls 106, 108, 110, 112 may be folded at an angle of approximately 90 degrees relative to the bottom panel 114 which is integrally connected to and located within the first, second, third and fourth sidewalls 106, 108, 110, 112.

According to one embodiment, the first sidewall 106 may have a first end 106a and a second end 106b, a second sidewall 108 may have a first end 108a and a second end 108b, a third sidewall 110 may have a first end 110a and a second end 110b, and a fourth sidewall 112 may have a first end 112a and a second end 112b. As shown, the first sidewall 106 may extend between the second end 108b of the second sidewall 108 and the second end 110b of the third sidewall 110. The second and third sidewalls 108, 110 may be located at an angle of approximately 45 degrees relative to the first sidewall 106. The fourth sidewall 112 may be located between the first end 108a of the second sidewall 108 and the first end 110a of the third sidewall section 110.

According to one embodiment, the first sidewall 106 may include an inner surface 106c and an outer surface 106d (See FIG. 6) integrally connected by a top surface 106e, the second sidewall 108 may include an inner surface 108c and an outer surface 108d integrally connected by a top surface 108e, the third sidewall 110 may include an inner surface 110c and an outer surface 110d integrally connected by a top surface 110e, and the fourth sidewall 112 may include an inner surface 112c and an outer surface 112d integrally connected by a top surface 112e. Furthermore, the outer perimeter of the bottom panel 114 may form the bottom surfaces of the four (4) sidewalls 106, 108, 110, 112. Additionally, the top surface 112e of the fourth sidewall 112 may be integrally connected to the top surface 110e of the third sidewall 110.

The first sidewall 106 may include one or more slots 120 to provide access for installation tools, such as screwdrivers. The second and third sidewalls 110, 114 may include a first plurality of holes 122 and a second plurality of holes 124, respectively, for fastening the structural bracket to an equipment rack, as discussed in more detail below. The shape of the structural bracket allows for a relatively thin component to carry high loads through mechanical interference and friction as well as allows a manufacture to ship a bolt together frame without losing structural strength.

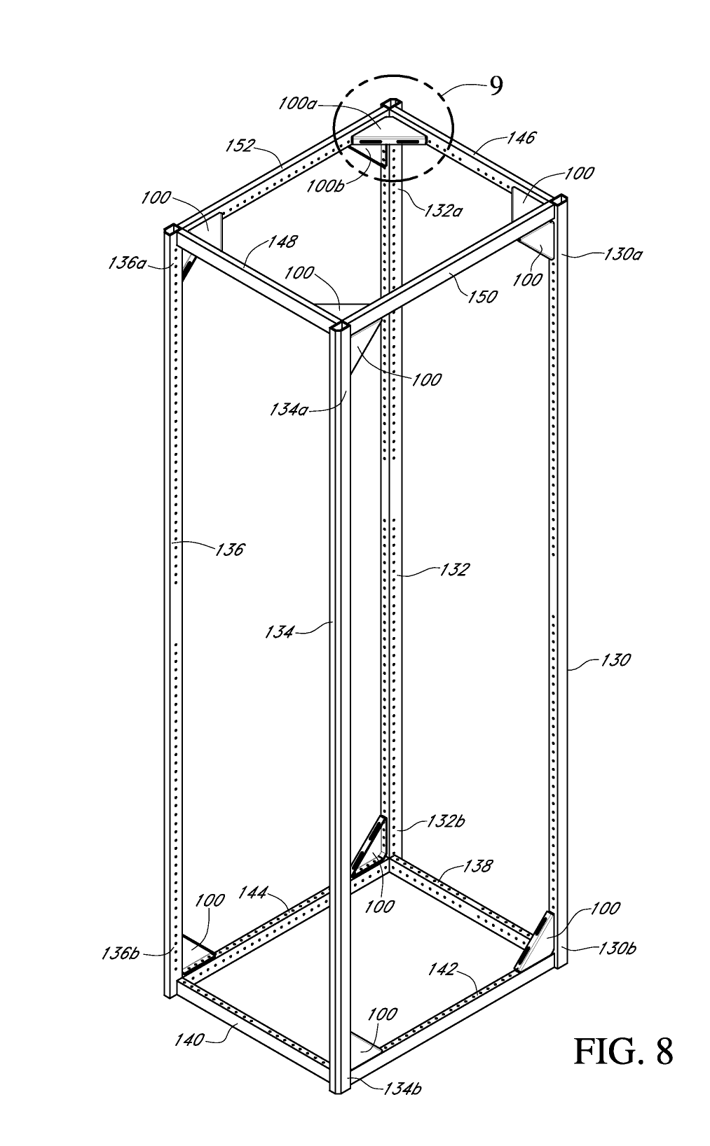

FIG. 8 illustrates the structural bracket 100 of FIG. 1 in an assembled equipment rack. As shown, the assembled equipment rack may comprise four vertical rails 130, 132, 134, 136, having top ends 130a, 132a, 134a, 136a and bottom ends 130b, 132b, 134b, 136b, separated by four (4) bottom horizontal rails 138, 140, 142, 144 at the bottom ends 130b, 132b, 134b, 136b and four (4) top horizontal rails 146, 148, 150, 152 at the top ends 130a, 132a, 134a, 136a. The four vertical rails 130, 132, 134, 136 may be secured to the bottom horizontal rails 138, 140, 142, 144 and the top horizontal rails 146, 148, 150, 152 by structural brackets.

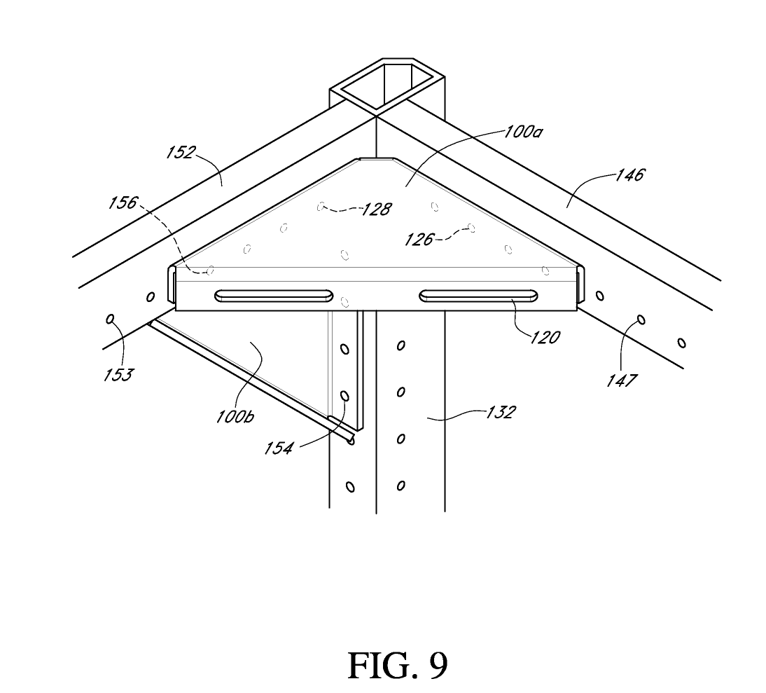

FIG. 9 illustrates an enlarged perspective view of detail A of FIG. 8. As shown, a first structural bracket 100a may be used to connect the top horizontal rails 146, 152 together while a second structural bracket 100b bracket may be used to connect vertical rail 132 with horizontal rail 152.

A first set of fasteners 126 may be inserted into the first plurality of holes 122 to secure the second sidewall 110 of the first structural bracket 100a to the horizontal frame 146 (via holes 147 in the horizontal frame 146) and a second set of fasteners 128 may be inserted into the second plurality of holes 124 to secure the third sidewall 114 of the first structural bracket 101a to the horizontal frame 152 (via holes 153 in the horizontal frame 152). As discussed above, the fasteners 126, 128 may be pre-loaded into the first plurality of holes 122 and the second plurality of holes 124, respectively, to produce friction interference. An installation tool may then be extended through the slots 120 and utilized to secure the fasteners within the holes 122, 124.

Similarly, the second structural bracket 100b may include a third set of fasteners 154 preloaded into a third plurality of holes (not shown) for securing the second sidewall of the second structural bracket 100b to the vertical rail 132 and a fourth set of fasteners 156 preloaded into a fourth plurality of holes (not shown) for securing the third sidewall of the second structural bracket 100b to the horizontal rail 152.

### Bisected Structural Bracket

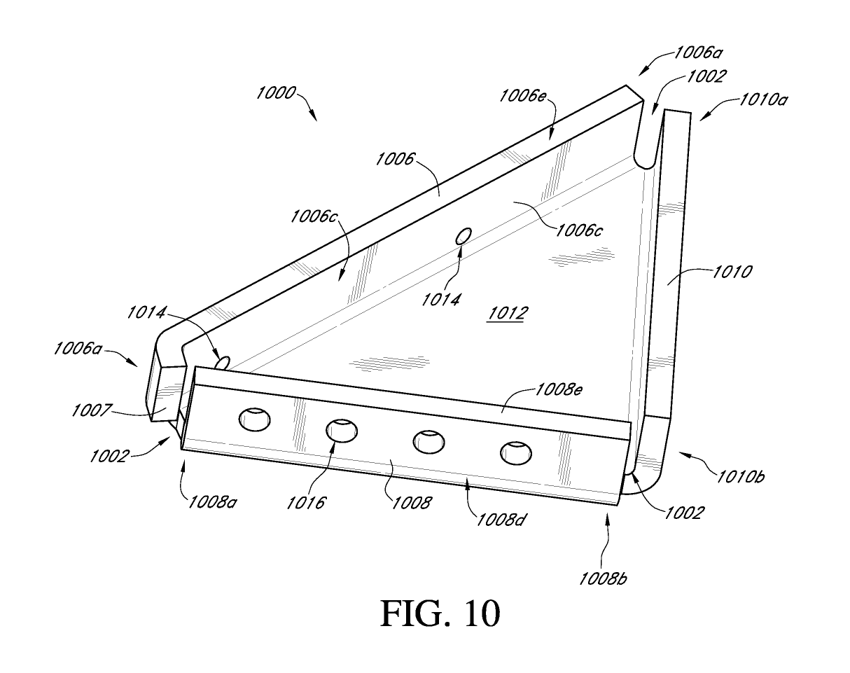

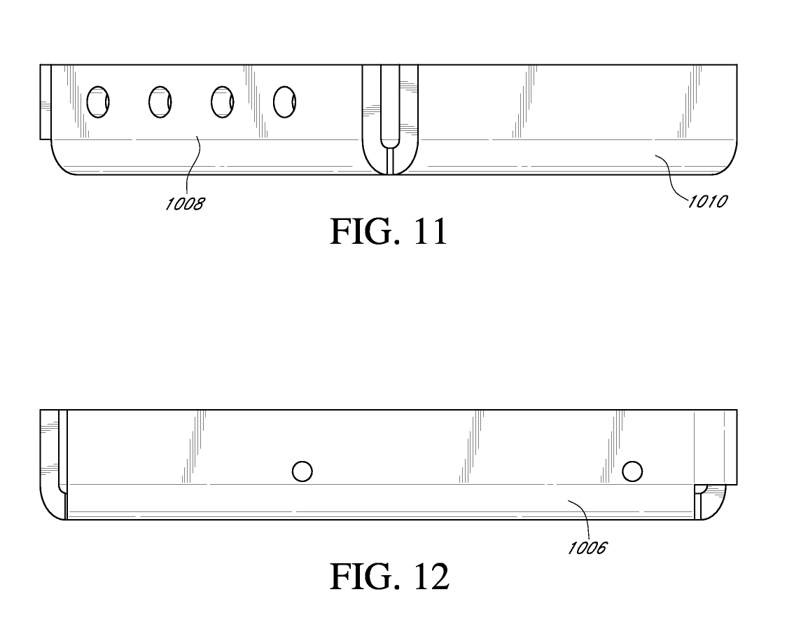

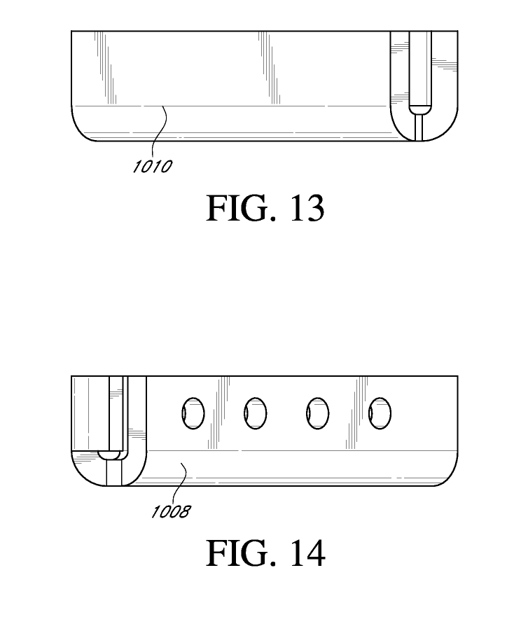

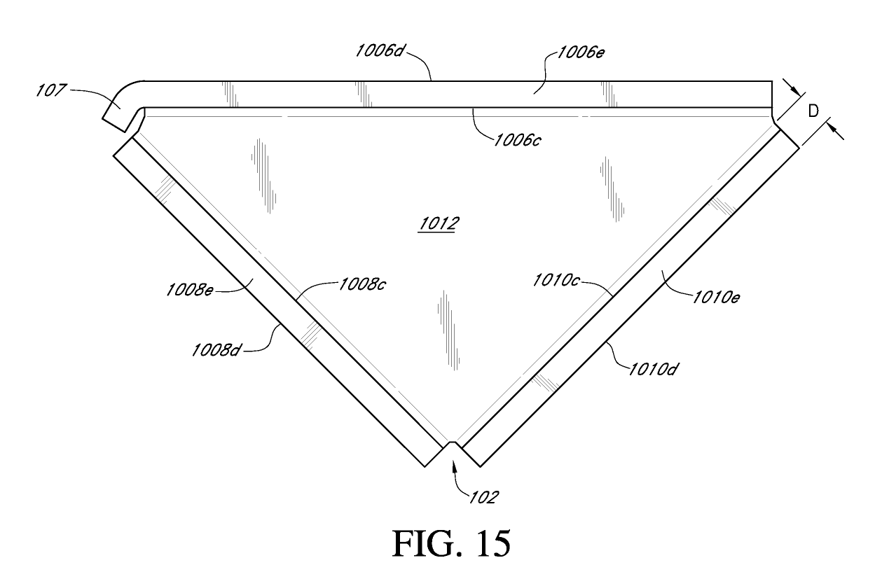

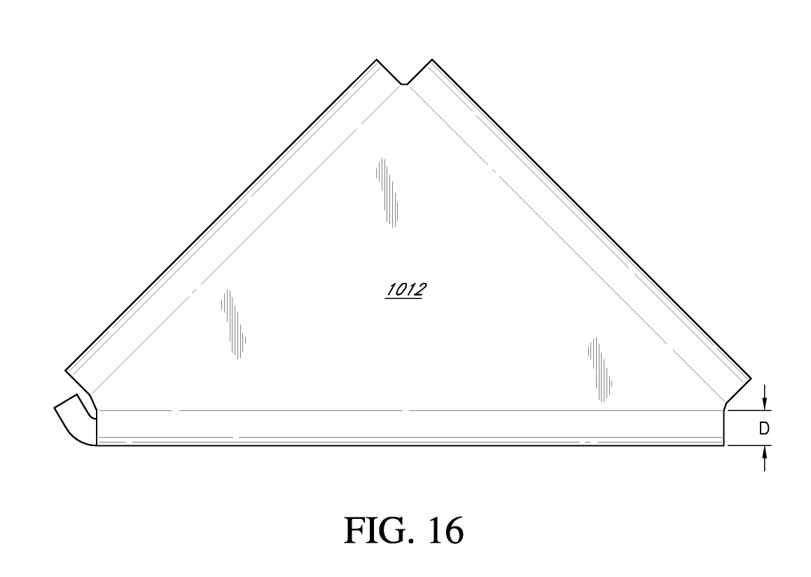

FIG. 10 illustrates a top perspective view of a structural bracket, according to one embodiment. FIG. 11 illustrates a front side elevation view of the structural bracket of FIG. 10. FIG. 12 illustrates a back side elevation view of the structural bracket of FIG. 10. FIG. 13 illustrates a right side elevation view of the structural bracket of FIG. 10. FIG. 14 illustrates a left side elevation view of the structural bracket of FIG. 10. FIG. 15 illustrates a top plan view of the structural bracket of FIG. 10. FIG. 16 illustrates a bottom plan view of the structural bracket of FIG. 10. The following discussion refers interchangeably to FIGS. 10-16.

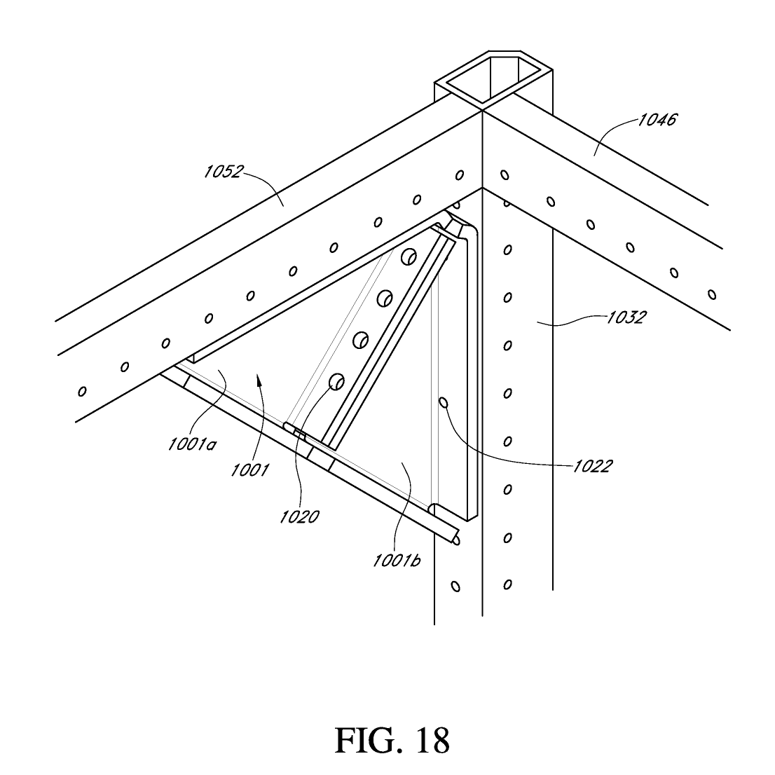

The structural bracket 1000 may be used to provide a flat pack solution for hardware racks while being as structurally strong as a traditional, fully welded frame. To obtain the structural integrity of a traditional, fully welded frame, a pair of structural brackets 1000 may be secured together by fasteners 1020 forming a single bisected structural bracket 1001 (See FIG. 18). The bisected structural bracket 1001 may load fasteners in an ideal loading condition. With a traditional structural bracket, the fasteners used would have to handle high shear loads, thereby requiring the use of larger fasteners in greater numbers. However, the bisected bracket 1001 may be designed so that the fasteners used are placed largely in either a compression or tensile loading condition, which is the ideal loading condition for fasteners. The resulting bisected structural bracket may be utilized for a flat pack frame that is as strong as a fully welded frame, but has a fewer number of smaller sized fasteners. Consequently, a manufacturer may ship a bolt together with a frame without losing structural strength.

According to one embodiment, a single flat sheet of metal, having a generally rectangular configuration, may be used to form the structural bracket 1000. Portions of metal 1002 may be removed at strategic locations in the sheet of metal to create flaps that may be folded over to form the sidewalls of the bracket. As shown in FIGS. 15-16, the removed portions of metal 1002 may be located at corners of the sheet of metal and extend inwardly a distance D (See FIGS. 15-16), where D is equal to the vertical length of the sidewalls where the vertical length is perpendicular to a bottom panel 1012.

The single flat sheet of metal may have an upper surface and a lower surface opposite the upper surface. The distance between the upper surface and the lower surface may correspond to the vertical height or the thickness of the flat sheet of metal. The removed portions of metal 1002 may extend inwardly a distance D, as discussed above. According to one embodiment, in one corner a portion of metal may be removed such that the sidewall created extends beyond the bottom panel creating a flap 1007.

According to one embodiment, first, second, and third sidewalls 1006, 1008, 1010, may be folded at an angle of approximately 90 degrees relative to the bottom panel 1012 which is integrally connected to and located within the first, second, and third sidewalls 1006, 1008, 1010.

According to one embodiment, the first sidewall 1006 may have a first end 1006a and a second end 1006b where the second end forms the flap 1007 as discussed above, a second sidewall 1008 may have a first end 1008a and a second end 1008b and the third sidewall 1010 may have a first end 1010a and a second end 1010b. As shown, the first sidewall 1006 may extend between the second end 1008b of the second sidewall 1008 and the second end 1010b of the third sidewall 1010. The second and third sidewalls 1008, 1010 may be located at an angle of approximately 45 degrees relative to the first sidewall 1006 and converge to a removed portion of metal 1002 (i.e. notch) directly opposite the first sidewall 1006.

According to one embodiment, the first sidewall 1006 may include an inner surface 1006c and an outer surface 1006d (See FIG. 15) integrally connected by a top surface 1006e, the second sidewall 1008 may include an inner surface 1008c and an outer surface 1008d integrally connected by a top surface 1008e, and the third sidewall 1010 may include an inner surface 1010c and an outer surface 1010d integrally connected by a top surface 1010e. Furthermore, the outer perimeter of the bottom panel 1012 may form the bottom surfaces of the three (3) sidewalls 1006, 1008, 1010.

The first sidewall 1006 may include one or more mounting holes 1014 for securing to a rail of a frame. The second sidewall 1008 may include first plurality of connecting holes 1016 for connect the second sidewall of a first structural bracket to the second sidewall of a second structural bracket forming the single bisected structural bracket 1001 (See FIG. 18). According to one embodiment, the third sidewall 1010 may have a solid flat surface.

The bisected structural bracket 1001 may allow for fasteners 1022 (See FIG. 18) to be loaded axially. Additionally, fewer fasteners, compared to traditional structural brackets, are needed which provides an easy to manufacture part and accurate frame alignment by the user.

According to one embodiment, both welding and fasteners may be utilized in the assembly of the frame. This combination of attachment methods with the bisected design offers high structural performance and modularity.

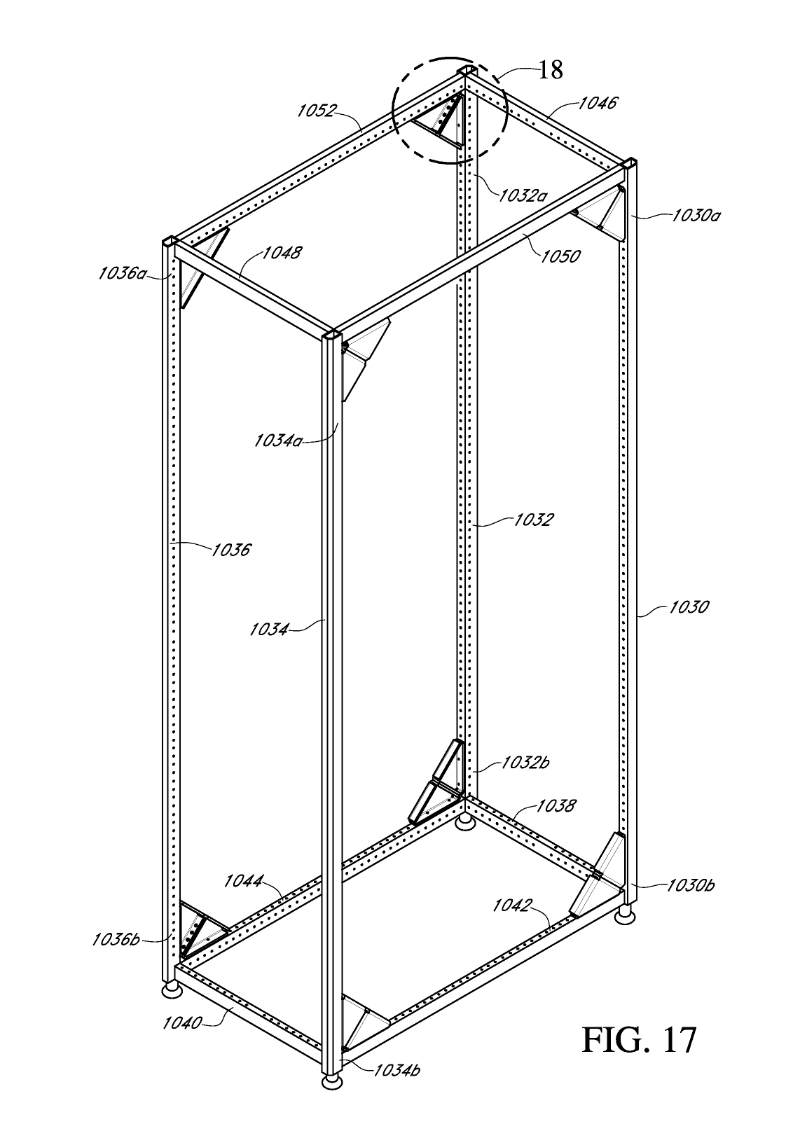

FIG. 17 illustrates a bisected structural bracket 1001 in an assembled equipment rack. As shown, the assembled equipment rack may comprise four vertical rails 1030, 1032, 1034, 1036, having top ends 1030a, 1032a, 1034a, 1036a and bottom ends 1030b, 1032b, 1034b, 1036b, separated by four (4) bottom horizontal rails 1038, 1040, 1042, 1044 at the bottom ends 1030b, 1032b, 1034b, 1036b and four (4) top horizontal rails 1046, 1048, 1050, 1052 at the top ends 1030a, 1032a, 1034a, 1036a. The four vertical rails 1030, 1032, 1034, 1036 may be secured to the bottom horizontal rails 1038, 1040, 1042, 1044 and the top horizontal rails 1046, 1048, 1050, 1052 by bisected structural brackets.

FIG. 18 illustrates an enlarged perspective view of detail A of FIG. 17. As shown, a pair of structural brackets may be secured together to form a bisected structural bracket 1001.

As discussed above, fasteners 1022 may be loaded axially and may be utilized to secure the bisected structural member 1001 to the frame. As shown, the first sidewall of the first structural member 1001a of the bisected structural member 1001 may secure the bisected structural member 1001 to the horizontal rail 1052 and the first sidewall of the second structural member 1001b of the bisected structural member 1001 may secure the bisected structural member 1001 to the vertical rail 1032

### Flanged Lap Joint Bracket

Flanged lap structural brackets for flat pack frames may provide a flat pack solution for hardware/equipment racks, or frames, while being as structurally strong as a fully welded frame. The flat pack feature of the rack is enabled by unique flanges that are used to create lap joints, which are compressed together via studs, such as PEM® studs, and nuts. The high compressive load from the fasteners, such as PEM® fasteners, creates large frictional forces that provide structural rigidity. These flanges are unique in that they have been designed to be part of the structural rails/beams that compose the rack or frame. This eliminates many of the costly manufacturing processes that are required with most flat pack rack designs. The use of studs, such as PEM® studs, and nuts allow for flush side-to-side placement of multiple racks. Consequently, a manufacturer may ship a bolt together with a frame without losing structural strength.

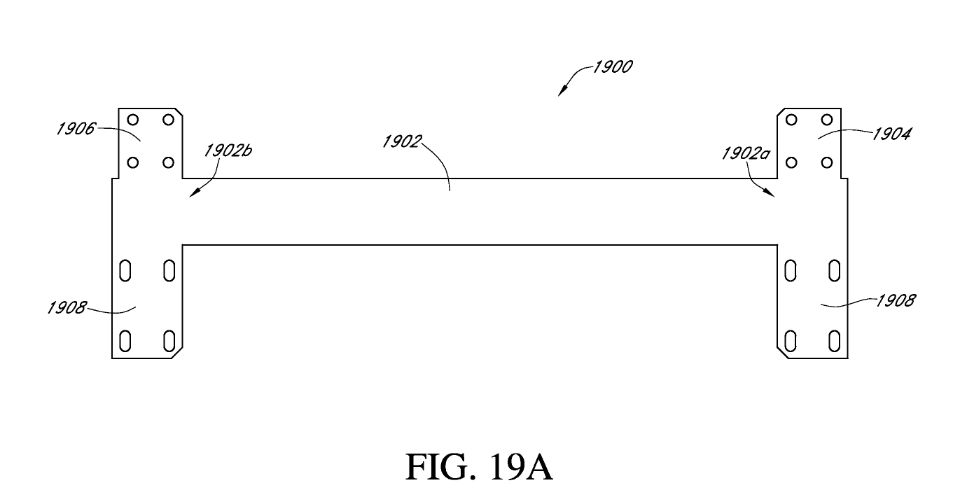

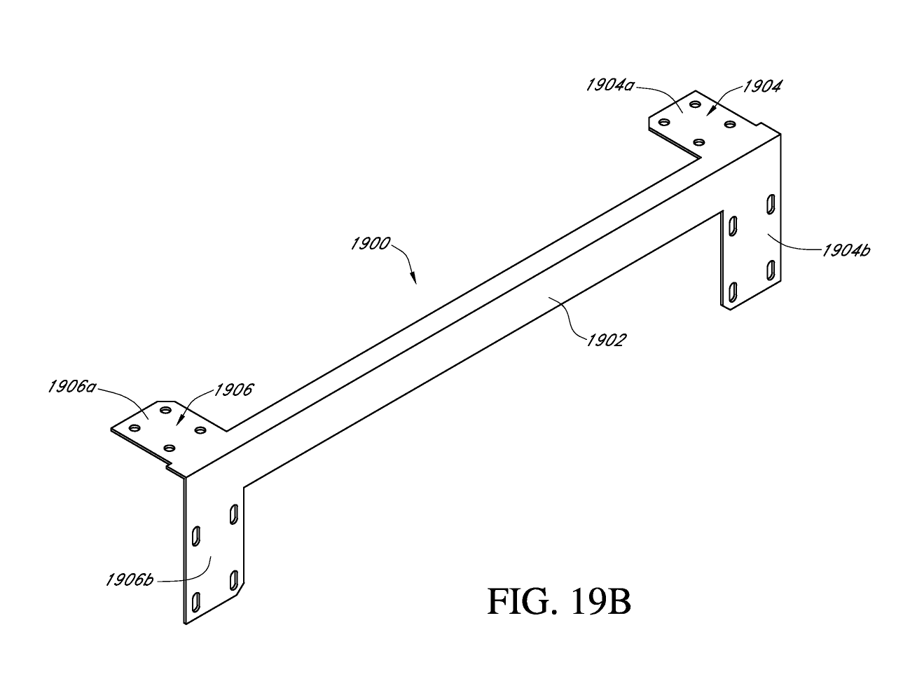

FIG. 19A illustrates a flanged lap joint bracket 1900 in a flat configuration for use in a flat pack equipment rack, according to one embodiment. As with the structural brackets described above, the flanged lap joint bracket 1900 may be comprised of a single sheet of metal that includes an elongated member 1902 having a first flange 1904, located at and extending perpendicularly from a first end 1902a of the elongated member 1902, and a second flange 1906 located at and extending perpendicularly from a second end 1902b of the elongated member 1902. The first flange 1904 may have a first attachment end 1904a and a second attachment end 1904b and the second flange 1906 may have a first attachment end 1906a and a second attachment end 1906b. Each of the attachment ends 1904a, 1904b, 1906a, 1906b may include a plurality of holes 1908 for receiving fasteners for securing the flanged lap joint bracket during assembly of the rack. FIG. 19B illustrates the flanged lap joint bracket of FIG. 19A in a formed configuration. That is, the elongated member 1902 of the single sheet of metal has been folded such that a first attachment end 1904a of the first flange 1904 is integrally connected and perpendicular to a second attachment end 1904b of the first flange 1904.

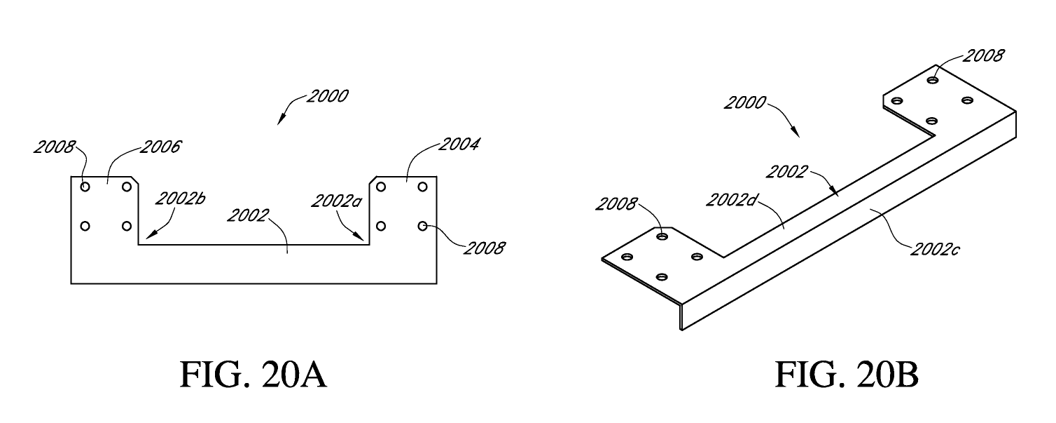

FIG. 20A illustrates a flanged lap joint bracket in a flat configuration for use in an equipment rack, according to one embodiment. As with the structural brackets described above, the flanged lap joint bracket 2000 may be comprised of a single sheet of metal that includes an elongated member 2002 having a first flange 2004, located at and extending perpendicularly from a first end 2002a of the elongated member 2002, and a second flange 2006 located at and extending perpendicularly from a second end 2002b of the elongated member 2002. The first flange 2004 and the second flange 2006 may include a plurality of holes 2008 for receiving fasteners for securing the flanged lap joint bracket during assembly of the rack. FIG. 20B illustrates the flanged lap joint bracket of FIG. 20A in a formed configuration. That is, the elongated member 2002 of the single sheet of metal has been folded to create a first side 2002c and a second side 2002d where the first side 2002c is integrally connected to and approximately perpendicular to the second side 2002d. The first flange 2004 may be integrally connected to the second side 2002d of the elongate member 2002 at the first end 2002a and the second flange 2006 may be integrally connected to the second side 2002d of the elongate member 2002 at the second end 2002b.

A flanged lap joint bracket for flat pack frames may utilize flanges formed as features that are part of the elongated member (e.g. rail or beam) eliminating many of the costly manufacturing processes that are required in a traditional flat pack design. Additionally, studs, such as PEM® studs, may be used for providing flush side-to-side placement of multiple racks. Together with the flanges and fasteners, such as PEM® fasteners, high friction lap joints may be created to provide structural rigidity. Utilizing flanged lap joint brackets, disclosed herein, may allow for half (½) of the frame gusset to be incorporated into each frame component. That is, the mating of the two flanges may create a rigid gusset.

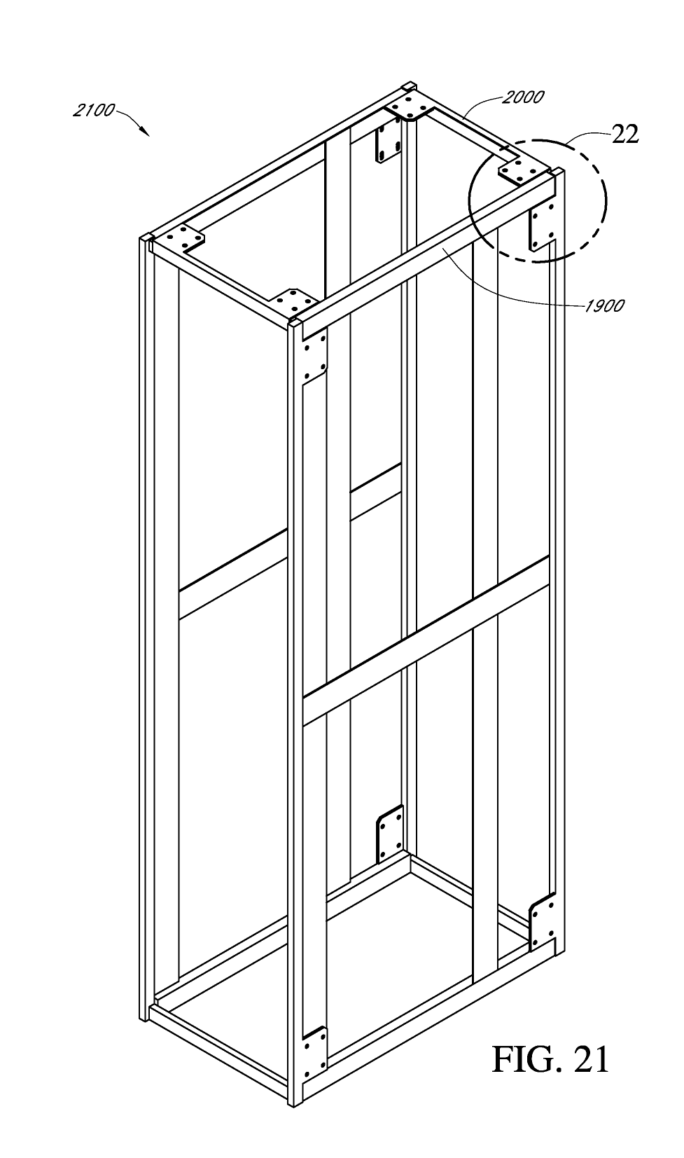

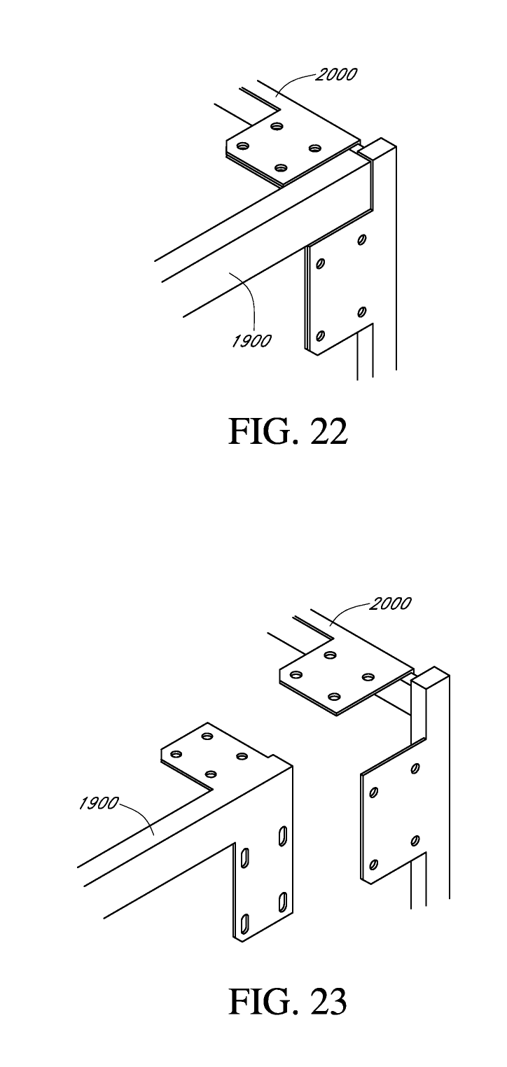

FIG. 21 illustrates an equipment rack assembled 2100 using flanged lap joint brackets of FIGS. 19B and 20B. In the assembled equipment rack 2100, for example, a single sided flanged lap joint bracket 2000 (See FIG. 20B) may be utilized as a vertical rail while a double sided flanged lap joint bracket 1900 (See FIG. 19B) may be utilized as a horizontal rail. The second attachment end 1904b of the first flange 1904 of the double sided flanged lap joint bracket 1900 may be secured to the first flange 2004 of the single sided flanged lap joint bracket 2000. The double sided flanged lap joint bracket 1900 and the single sided flanged lap joint bracket 2000 may be secured together with fasteners, such as studs, washers and hex nuts. FIG. 22 illustrates enlarged perspective views of detail A and detail B of FIG. 21 showing the double sided flanged lap joint bracket 1900 secured to the single sided flanged lap joint bracket 2000. FIG. 23 illustrates a semi-exploded view of a lap joint bracket connection.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A structural bracket, comprising:
a single sheet of metal, comprising:
a bottom panel
a plurality of notches located at one or more locations on a perimeter of the bottom panel; and
a plurality of sidewalls integrally connected to the bottom panel and located between the plurality of notches;
where the plurality of sidewalls are folded approximately perpendicular to the bottom panel; and
where each sidewall in the plurality of sidewalls includes a bottom surface integrally connected with the perimeter of the bottom panel and a top surface opposite the bottom surface.

2. The structural bracket of claim 1, wherein the structural bracket has a triangular configuration.

3. The structural bracket of claim 1, wherein the plurality of sidewalls comprises:
a first sidewall having a first side end and a second side end;
a second sidewall having a first bottom end and a first top end, the first bottom end positioned at an angle of approximately 45 degrees from the first side end of the first sidewall; and
a third sidewall having a second bottom end and a second top end, the second bottom end positioned at an angle of approximately 45 degrees from the second side end of the first sidewall.

4. The structural bracket of claim 2, wherein the plurality of sidewalls further comprises a fourth sidewall integrally connected to the second top end of the third sidewall and positioned parallel to the first sidewall.

5. The structural bracket of claim 2, wherein the first sidewall includes one or more vertical slots.

6. The structural bracket of claim 2, wherein the second sidewall includes a first plurality of holes for receiving a first set of fasteners to secure the second sidewall to a first rail of an equipment frame; and wherein the third sidewall includes a second plurality of holes for receiving a second set of fasteners to secure the third sidewall to a second rail of the equipment frame.

7. The structural bracket of claim 6, wherein the equipment frame is a flat pack equipment frame.

8. The structural bracket of claim 3, wherein the first side of the first sidewall extends inwardly at an angle of approximately 45 degrees.

9. The structural bracket of claim 8, wherein the first sidewall includes one or more mounting holes for securing to a rail of an equipment frame.

10. The structural bracket of claim 9, wherein the equipment frame is a flat pack equipment frame.

11. The structural bracket of claim 8, wherein the second sidewall includes a first plurality of connecting holes; wherein the first plurality of connecting holes are aligned with a second plurality of connecting holes in a second sidewall of a second structural bracket; and
wherein securing the second sidewall of the structural bracket to the second sidewall of the second structural bracket forms a single bisected structural bracket.

12. The structural bracket of claim 11, wherein the second sidewall of the structural bracket is secured to the second sidewall of the second structural bracket with fasteners.

13. The structural bracket of claim 11, wherein the third sidewall of the structural bracket of the single bisected structural bracket is secured to a horizontal rail of the assembled equipment rack; and wherein a third sidewall of a second structural bracket of the single bisected structural bracket is secured to a vertical rail in the assembled equipment rack

14. The structural bracket of claim 3, wherein the third sidewall has a solid flat surface.

15. A flanged lap joint bracket, comprising:
a single sheet of metal, comprising:
an elongated member having a first end and a second end;
a first flange, having a first plurality of holes, integrally connected to and extending perpendicularly from the first end of the elongated member; and
a second flange, having a first plurality of holes, integrally connected to and extending perpendicularly from the second end of the elongated member; and
wherein the elongated member is folded to an angle of approximately 90 degrees.

16. The flanged lap joint bracket of claim 15, wherein the first flange has a first attachment end and a second attachment end, the second attachment end of the first flange integrally connected to and perpendicular to the first attachment end of the first flange; and
wherein the second flange has a first attachment end and a second attachment end, the second attachment end of the second flange integrally connected to and perpendicular to the first attachment end of the second flange.

17. The flanged lap joint bracket of claim 15, wherein the elongated member forms a vertical rail of an assembled equipment frame.

18. The flanged lap joint bracket of claim 17, wherein the equipment frame is a flat pack equipment frame.

19. The flanged lap joint bracket of claim 15, wherein the elongated member forms a horizontal rail of an assembled equipment frame.

20. The flanged lap joint bracket of claim 19, wherein the equipment frame is a flat pack equipment frame.
